(19) United States
(12) Patent Application Publication
(10) Pub. No.: US 2026/0296418 A1
(43) Pub. Date: Oct. 1, 2026

(54) INFORMATION PROCESSING APPARATUS, INFORMATION PROCESSING METHOD, AND PROGRAM

(71) Applicant: SONY GROUP CORPORATION, Tokyo (JP)

(72) Inventors: Seiji SUZUKI, Tokyo (JP); Shinichi IRIYA, Tokyo (JP); Katsuji MIYAZAWA, Tokyo (JP); Satoshi AKAGAWA, Tokyo (JP)

(21) Appl. No.: 19/480,712

(22) PCT Filed: Apr. 19, 2024
(86) PCT No.: PCT/JP2024/015585

§ 371 Date: Oct. 31, 2025

(30) Foreign Application Priority Data
May 10, 2023 (JP) 2023-077719

(51) Int. Cl. B60W 30/095; B60W 50/14

(52) U.S. Cl. CPC B60W 30/0956; B60W 50/14; B60W 2050/146

(57) ABSTRACT

The present technology relates to an information processing apparatus, an information processing method, and a program that enable information for avoiding danger to be presented more appropriately to a user of a moving body such as a vehicle.

An information processing apparatus according to the present technology includes a prediction unit which predicts movement information indicating a future movement of an object around a moving body and accident information indicating a movement of the object in a case where an accident occurs; a calculation unit which calculates a degree of danger of the object on the basis of the movement information and the accident information; and a presentation control unit which presents, to a user of the moving body, danger prediction information indicating the degree of danger of the object. The present technology can be applied to, for example, a moving body such as a vehicle.

### TECHNICAL FIELD

The present technology relates to an information processing apparatus, an information processing method, and a program, and, more particularly, to an information processing apparatus, an information processing method, and a program that enable information for avoiding danger to be presented more appropriately to a user of a moving body such as a vehicle.

### BACKGROUND ART

In recent years, introduction of an AR (Augmented Reality) technology into vehicles has progressed (see, for example, Patent Literature 1). For example, there is a technology in which, when an object that is an obstacle is detected by a sensor, a template indicating the object is superimposed on an image of surroundings of a vehicle to be displayed.

### CITATION LIST

### Patent Literature

Patent Literature 1: WO 2021/079975

### DISCLOSURE OF INVENTION

### Technical Problem

In the conventional technology, a degree of danger that is based on a prediction result of a movement of a vehicle and a position of an object is expressed by a size of the template and/or the like. However, since a movement of the object that is an obstacle is not predicted, the degree of danger is not calculated based on a prediction result of the movement of the object, or the prediction result of the movement of the object is not presented to a user of the vehicle, and thus sufficient information for avoiding danger is not displayed in some cases.

The present technology has been made in view of the circumstances as described above, and aims at enabling information for avoiding danger to be presented more appropriately to a user of a moving body such as a vehicle.

### Solution to Problem

An information processing apparatus according to an aspect of the present technology includes a prediction unit which predicts movement information indicating a future movement of an object around a moving body and accident information indicating a movement of the object in a case where an accident occurs; a calculation unit which calculates a degree of danger of the object on the basis of the movement information and the accident information; and a presentation control unit which presents, to a user of the moving body, danger prediction information indicating the degree of danger of the object.

An information processing method according to an aspect of the present technology is performed by an information processing apparatus, the information processing method including predicting movement information indicating a future movement of an object around a moving body and accident information indicating a movement of the object in a case where an accident occurs; calculating a degree of danger of the object on the basis of the movement information and the accident information; and presenting, to a user of the moving body, danger prediction information indicating the degree of danger of the object.

A program according to an aspect of the present technology causes a computer to execute processing including predicting movement information indicating a future movement of an object around a moving body and accident information indicating a movement of the object in a case where an accident occurs; calculating a degree of danger of the object on the basis of the movement information and the accident information; and presenting, to a user of the moving body, danger prediction information indicating the degree of danger of the object.

According to the aspect of the present technology, the movement information indicating the future movement of the object around the moving body and the accident information indicating the movement of the objects in the case where an accident occurs are predicted, the degree of danger of the object is calculated on the basis of the movement information and the accident information, and the danger prediction information indicating the degree of danger of the object is presented to the user of the moving body.

### BRIEF DESCRIPTION OF DRAWINGS

FIG. 1 is a block diagram showing a configuration example of a vehicle control system.

FIG. 2 is a diagram showing an example of sensing areas.

FIG. 3 is a block diagram showing a configuration example of a vehicle control system to which the present technology is applied.

FIG. 4 is a flowchart illustrating processing performed by the vehicle control system.

FIG. 5 is a diagram showing an example of danger prediction information.

FIG. 6 is a diagram showing an example of the danger prediction information indicating a degree of danger of a traveling vehicle.

FIG. 7 is a diagram showing an example of the danger prediction information indicating the degree of danger of a pedestrian crossing a crosswalk.

FIG. 8 is a diagram showing an example of the danger prediction information indicating the degree of danger of a bicycle.

FIG. 9 is a diagram showing an example of the danger prediction information indicating the degree of danger of a vehicle at a stop.

FIG. 10 is a diagram showing a display example of the danger prediction information.

FIG. 11 is a diagram showing a first modified example of the danger prediction information.

FIG. 12 is a diagram showing a second modified example of the danger prediction information.

FIG. 13 is a diagram showing a display example of the danger prediction information for securing visibility of the danger prediction information.

FIG. 14 is a diagram showing a display example of the danger prediction information for securing visibility of an object.

FIG. 15 is a diagram showing an example of dangerous environment information.

FIG. 16 is a diagram showing another example of the dangerous environment information.

FIG. 17 is a block diagram showing a configuration example of hardware of a computer.

### MODES FOR CARRYING OUT THE INVENTION

Hereinafter, modes for carrying out the present disclosure will be described. Descriptions will be given in the following order.
1. Configuration example of vehicle control system
2. Embodiment
3. Modified examples

### 1. Configuration Example of Vehicle Control System

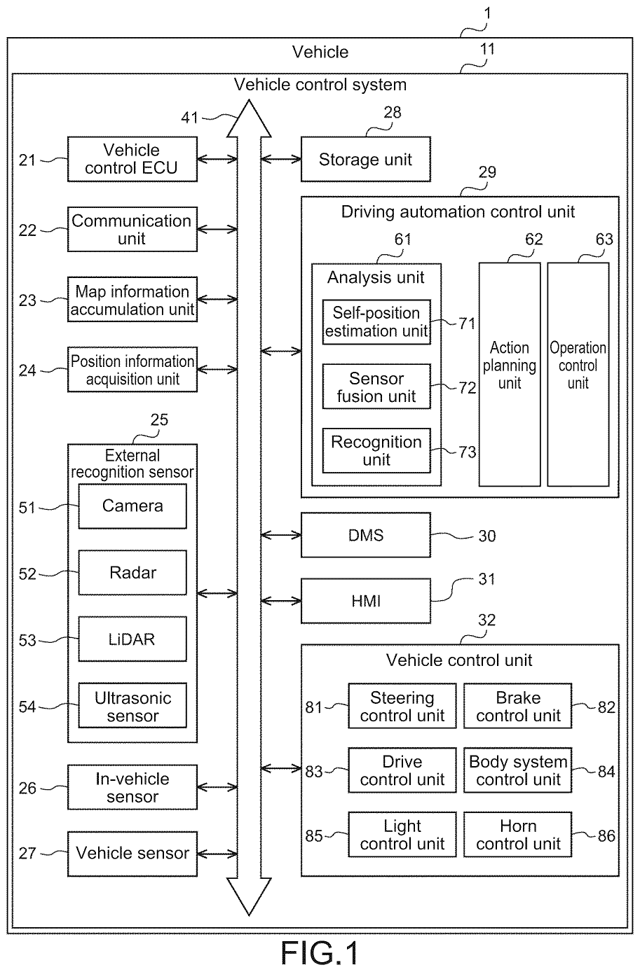

FIG. 1 is a block diagram showing a configuration example of a vehicle control system 11, which is an example of a mobile body control system to which the present technology is applied.

The vehicle control system 11 is provided in a vehicle 1 and performs processing related to driving automation of the vehicle 1. This driving automation may include driving automation of levels 1 to 5, and may include remote assistance and/or remote driving of the vehicle 1 by a remote driver.

The vehicle control system 11 includes a vehicle control ECU (Electronic Control Unit) 21, a communication unit 22, a map information accumulation unit 23, a position information acquisition unit 24, an external recognition sensor 25, an in-vehicle sensor 26, a vehicle sensor 27, a storage unit 28, a driving automation control unit 29, a DMS (Driver Monitoring System) 30, an HMI (Human Machine Interface) 31, and a vehicle control unit 32.

The vehicle control ECU 21, the communication unit 22, the map information accumulation unit 23, the position information acquisition unit 24, the external recognition sensor 25, the in-vehicle sensor 26, the vehicle sensor 27, the storage unit 28, the driving automation control unit 29, the DMS 30, the HMI 31, and the vehicle control unit 32 are communicably connected to each other via a communication network 41. The communication network 41 includes, for example, an in-vehicle communication network, a bus, and/or the like compliant with a digital bidirectional communication standard such as a CAN (Controller Area Network), a LIN (Local Interconnect Network), a LAN (Local Area Network), FlexRay®, or Ethernet®. The communication network 41 may be selectively used according to the type of data to be transmitted. For example, the CAN may be used for data related to vehicle control, and the Ethernet may be used for large-volume data. It is noted that the respective units of the vehicle control system 11 may be connected not via the communication network 41 but directly via wireless communication that assumes communication at a relatively short distance, such as near field communication (NFC) and Bluetooth®.

It is noted that hereinafter, when the respective units of the vehicle control system 11 communicate with each other via the communication network 41, the communication network 41 will not be described. For example, when the vehicle control ECU 21 and the communication unit 22 communicate with each other via the communication network 41, it is simply described that the vehicle control ECU 21 and the communication unit 22 communicate with each other.

The vehicle control ECU 21 is implemented by, for example, various processors, such as a CPU (Central Processing Unit) and/or an MPU (Micro Processing Unit). The vehicle control ECU 21 controls all or a part of the functions of the vehicle control system 11.

The communication unit 22 communicates with various devices inside the vehicle and outside the vehicle, other vehicles, servers, base stations, and/or the like, to transmit and receive various types of data. At this time, the communication unit 22 can communicate using a plurality of communication technologies.

Communication that the communication unit 22 is capable of executing with devices outside the vehicle will be schematically described. The communication unit 22 communicates with a server or the like existing on an external network (hereinafter, will be referred to as an external server) via a base station or an access point by a wireless communication technology, the examples of which include 5G (5th Generation Mobile Communication System), LTE (Long Term Evolution), DSRC (Dedicated Short Range Communications), and the like. The external network with which the communication unit 22 communicates is, for example, the Internet, a cloud network, a company-specific network, or the like. The communication technology used by the communication unit 22 to communicate with the external network is not particularly limited as long as it is a wireless communication technology that enables digital bidirectional communication at a communication speed equal to or more than a predetermined speed and at a distance equal to or more than a predetermined distance.

Further, for example, the communication unit 22 can communicate with terminals existing in the vicinity of the vehicle using a P2P (Peer To Peer) technology. The terminals existing in the vicinity of the vehicle include, for example, a terminal worn by a moving body moving at a relatively low speed, such as a pedestrian or a bicycle, a terminal installed at a fixed position in a store or the like, and/or an MTC (Machine Type Communication) terminal. In addition, the communication unit 22 can also perform V2X communication. V2X communication refers to communication between a vehicle and another entity, the examples of which include vehicle-to-vehicle communication with another vehicle, vehicle-to-infrastructure communication with a roadside device or the like, vehicle-to-home communication with a home, vehicle-to-pedestrian communication with a terminal or the like carried or worn by a pedestrian, and the like.

For example, the communication unit 22 can receive a program for updating software for controlling the operation of the vehicle control system 11 from outside (Over The Air). In addition, the communication unit 22 can receive map information, traffic information, information on surroundings of the vehicle 1, and/or the like from outside. Further, for example, the communication unit 22 can transmit information related to the vehicle 1, information on the surroundings of the vehicle 1, and/or the like to the outside. Examples of the information related to the vehicle 1 that is transmitted to the outside by the communication unit 22 include data indicating the state of the vehicle 1, a recognition result by a recognition unit 73, and the like. Furthermore, the communication unit 22 performs communication that supports a vehicle emergency call system, an example of which is eCall.

For example, the communication unit 22 receives an electromagnetic wave transmitted by a road traffic information communication system (VICS (Vehicle Information and Communication System)®) using a radio wave beacon, an optical beacon, FM multiplex broadcasting, and/or the like.

The communication that the communication unit 22 is capable of executing with the in-vehicle devices will be schematically described. The communication unit 22 can communicate with the in-vehicle devices using wireless communication, for example. For example, the communication unit 22 can wirelessly communicate with an in-vehicle device by any wireless communication technology that enables digital bidirectional communication at a communication speed equal to or more than a predetermined speed, examples of the wireless communication technologies including wireless LAN, Bluetooth, NFC, and WUSB (Wireless USB). The communication unit 22 is not limited thereto, and the communication unit 22 can also communicate with the in-vehicle devices using wired communication. For example, the communication unit 22 can communicate with the in-vehicle devices by wired communication via a cable connected to a connection terminal (not shown). The communication unit 22 can communicate with the in-vehicle devices by any wired communication technology that enables digital bidirectional communication at a communication speed equal to or more than a predetermined speed, examples of the wired communication technologies including USB (Universal Serial Bus), HDMI (High-Definition Multimedia Interface)®, and MHL (Mobile High-definition Link).

Here, the in-vehicle devices with which the communication unit 22 communicates refer to, for example, devices that are not connected to the communication network 41 in the vehicle. Assumed as the in-vehicle devices are, for example, a mobile device or a wearable device carried by a user in the vehicle such as a driver, an information device brought in and temporarily installed in the vehicle, and the like.

The map information accumulation unit 23 accumulates a map acquired from outside and/or a map created by the vehicle 1. For example, the map information accumulation unit 23 accumulates a three-dimensional high-precision map, a global map having lower precision than the high-precision map and covering a wide area, and/or the like.

The high-precision map is, for example, a dynamic map, a point cloud map, a vector map, or the like. The dynamic map is, for example, a map including four layers of dynamic information, semi-dynamic information, semi-static information, and static information, and is provided to the vehicle 1 from an external server or the like. The point cloud map is a map including a point cloud (point group data). The vector map is, for example, a map in which traffic information such as positions of lanes and/or traffic lights is associated with a point cloud map, for adaptation to driving automation.

The point cloud map and the vector map may be, for example, provided from an external server or the like, or may be created by the vehicle 1 as a map to be matched with a local map to be described later based on sensing results by a camera 51, a radar 52, a LiDAR 53, and the like, and may be accumulated in the map information accumulation unit 23. Furthermore, in a case where a high-precision map is provided from an external server or the like, for example, map data of several hundred square meters regarding a planned path on which the vehicle 1 is to travel may be acquired from the external server or the like in order to reduce the amount of communication.

The position information acquisition unit 24 receives GNSS (Global Navigation Satellite System) signals from a GNSS satellite to acquire position information of the vehicle 1. The acquired position information is supplied to the driving automation control unit 29. It is noted that the position information acquisition unit 24 is not limited to using GNSS signals, and the position information may be acquired using a beacon, for example.

The external recognition sensor 25 includes various sensors used for recognizing a situation outside the vehicle 1, and supplies sensor data from the sensors to the respective units of the vehicle control system 11. The external recognition sensor 25 may include any type and any number of sensors.

For example, the external recognition sensor 25 may include the camera 51, the radar 52, the LiDAR (Light Detection and Ranging/Laser Imaging Detection and Ranging) 53, and an ultrasonic sensor 54. The external recognition sensor 25 is not limited thereto, and the external recognition sensor 25 may include one or more types of sensors among the camera 51, the radar 52, the LiDAR 53, and the ultrasonic sensor 54. The numbers of the cameras 51, the radars 52, the LiDAR 53, and the ultrasonic sensors 54 are not particularly limited as long as they can be practically installed in the vehicle 1. Furthermore, the type of sensor included in the external recognition sensor 25 is not limited to this example, and the external recognition sensor 25 may include another type of sensor. An example of the sensing area of each sensor included in the external recognition sensor 25 will be described later.

It is noted that the imaging method of the camera 51 is not particularly limited. For example, cameras that use various imaging methods with which distance measurement can be performed, such as a ToF (Time Of Flight) camera, a stereo camera, a monocular camera, and an infrared camera can be applied to the camera 51 as necessary. The camera 51 is not limited thereto and may be a camera for simply acquiring a captured image regardless of distance measurement.

Further, for example, the external recognition sensor 25 can include an environment sensor for detecting an environment with respect to the vehicle 1. The environment sensor is a sensor for detecting the environment such as a weather, a meteorological phenomenon, and brightness, and can include, for example, various sensors such as a rain drop sensor, a fog sensor, a sunshine sensor, a snow sensor, and an illuminance sensor.

In addition, for example, the external recognition sensor 25 includes a microphone used for detecting sound around the vehicle 1, a position of a sound source, and/or the like.

The in-vehicle sensor 26 includes various sensors for detecting information inside the vehicle, and supplies sensor data from the various sensors to the respective units of the vehicle control system 11. The type and number of the various sensors included in the in-vehicle sensor 26 are not particularly limited as long as the types and numbers allow practical installation of the sensors in the vehicle 1.

For example, the in-vehicle sensor 26 can include one or more types of sensors among a camera, a radar, a seating sensor, a steering wheel sensor, a microphone, and a biological sensor. As the camera included in the in-vehicle sensor 26, for example, cameras that use various imaging methods with which distance measurement can be performed, such as a ToF camera, a stereo camera, a monocular camera, and an infrared camera, can be used. The camera included in the in-vehicle sensor 26 is not limited thereto, and the camera may be a camera for simply acquiring a captured image regardless of distance measurement. The biological sensor included in the in-vehicle sensor 26 may be provided in, for example, a seat, a steering wheel, or the like, and may detect various types of biological information of a user.

The vehicle sensor 27 includes various sensors for detecting the state of the vehicle 1, and supplies sensor data from the various sensors to the respective units of the vehicle control system 11. The type and number of the various sensors included in the vehicle sensor 27 are not particularly limited as long as the types and numbers allow practical installation of the sensors in the vehicle 1.

For example, the vehicle sensor 27 includes a speed sensor, an acceleration sensor, an angular velocity sensor (gyro sensor), and an inertial measurement unit (IMU) integrating these sensors. For example, the vehicle sensor 27 includes a steering angle sensor that detects a steering angle of a steering wheel, a yaw rate sensor, an accelerator sensor that detects an operation amount of an accelerator pedal, and a brake sensor that detects an operation amount of a brake pedal. For example, the vehicle sensor 27 includes a rotation sensor that detects the rotation speed of an engine or a motor, an air pressure sensor that detects the air pressure of a tire, a slip rate sensor that detects the slip rate of a tire, and a wheel speed sensor that detects the rotation speed of a wheel. For example, the vehicle sensor 27 includes a battery sensor that detects a remaining amount and a temperature of a battery, and an impact sensor that detects an external impact.

The storage unit 28 includes at least one of a nonvolatile storage medium or a volatile storage medium, and stores data and a program. The storage unit 28 is used as, for example, an EEPROM (Electrically Erasable Programmable Read Only Memory) and a RAM (Random Access Memory), and a magnetic storage device such as an HDD (Hard Disc Drive), a semiconductor storage device, an optical storage device, and a magneto-optical storage device can be applied as the storage medium. The storage unit 28 stores various programs and data used by the respective units of the vehicle control system 11. For example, the storage unit 28 includes an EDR (Event Data Recorder) and/or a DSSAD (Data Storage System for Automated Driving), and stores information of the vehicle 1 before and after an event such as an accident and/or information acquired by the in-vehicle sensor 26.

The driving automation control unit 29 controls a driving automation function of the vehicle 1. For example, the driving automation control unit 29 includes an analysis unit 61, an action planning unit 62, and an operation control unit 63.

The analysis unit 61 performs analysis processing of the situation of the vehicle 1 and/or a situation around the vehicle 1. The analysis unit 61 includes a self-position estimation unit 71, a sensor fusion unit 72, and the recognition unit 73.

The self-position estimation unit 71 estimates the self-position of the vehicle 1 based on sensor data from the external recognition sensor 25 and a high-precision map accumulated in the map information accumulation unit 23. For example, the self-position estimation unit 71 estimates the self-position of the vehicle 1 by generating a local map based on sensor data from the external recognition sensor 25 and matching the local map with the high-precision map. As the position of the vehicle 1, for example, the center of the rear wheel pair axle is used as a reference.

For example, the local map is a three-dimensional high-precision map created using a technology such as SLAM (Simultaneous Localization and Mapping), an occupancy grid map, and/or the like. The three-dimensional high-precision map is, for example, the above-described point cloud map or the like. The occupancy grid map is a map in which a three-dimensional or two-dimensional space around the vehicle 1 is divided into grids of a predetermined size, and an occupancy state of an object is indicated for each grid. The occupancy state of an object is indicated by, for example, the presence or absence or a presence probability of the object. The local map is also used for, for example, detection processing and recognition processing of a situation outside the vehicle 1 by the recognition unit 73.

It is noted that the self-position estimation unit 71 may estimate the self-position of the vehicle 1 based on the position information acquired by the position information acquisition unit 24 and the sensor data from the vehicle sensor 27.

The sensor fusion unit 72 performs sensor fusion processing of combining a plurality of different types of sensor data (for example, image data supplied from the camera 51 and sensor data supplied from the radar 52) to obtain information. Methods for combining different types of sensor data include composite, integration, fusion, association, and the like.

The recognition unit 73 performs detection processing of detecting a situation outside the vehicle 1 and recognition processing of recognizing a situation outside the vehicle 1.

For example, the recognition unit 73 performs the detection processing and the recognition processing of a situation outside the vehicle 1 based on information from the external recognition sensor 25, information from the self-position estimation unit 71, information from the sensor fusion unit 72, and/or the like.

Specifically, for example, the recognition unit 73 performs the detection processing, the recognition processing, and/or the like of an object around the vehicle 1. The detection processing of an object is, for example, processing of detecting the presence or absence, size, shape, position, movement (for example, a content of the movement, a movement direction, and a movement speed), and/or the like of an object. The recognition processing of an object is, for example, processing of recognizing an attribute such as a type of an object and/or identifying a specific object. The detection processing and the recognition processing are not necessarily divided clearly, and may be duplicative.

For example, the recognition unit 73 detects an object around the vehicle 1 by performing clustering to classify a point cloud that is based on sensor data from the radar 52, the LiDAR 53, or the like into clusters of point groups. Accordingly, the presence or absence, size, shape, and/or position of an object around the vehicle 1 are detected.

For example, the recognition unit 73 detects the movement of an object around the vehicle 1 by tracking the movement of the clusters of point groups classified by clustering. Accordingly, the speed and the traveling direction (movement vector) of the object around the vehicle 1 are detected.

For example, the recognition unit 73 detects or recognizes a vehicle, a person, a bicycle, an obstacle, a structure, a road, a traffic light, a traffic sign, a road sign, and/or the like based on the image data supplied from the camera 51. Further, the recognition unit 73 recognizes the type of an object around the vehicle 1 by performing recognition processing such as semantic segmentation.

For example, the recognition unit 73 can perform recognition processing of traffic rules around the vehicle 1 based on a map accumulated in the map information accumulation unit 23, an estimation result of the self-position by the self-position estimation unit 71, and a recognition result of an object around the vehicle 1 by the recognition unit 73. Through this processing, the recognition unit 73 can recognize the position and state of a traffic light, the contents of a traffic sign and a road sign, the contents of a traffic regulation, a travelable lane, and/or the like.

For example, the recognition unit 73 can perform recognition processing of the environment around the vehicle 1. A weather, a temperature, a humidity, brightness, a state of the road surface, and the like are assumed as the surrounding environment to be recognized by the recognition unit 73.

The action planning unit 62 creates an action plan of the vehicle 1. For example, the action planning unit 62 creates an action plan by performing processing of path planning and path following.

It is noted that the path planning includes global path planning and local path planning. The global path planning includes processing of planning a rough path from the start to the goal. The local path planning, which is also referred to as trajectory planning, includes processing of generating a trajectory in the vicinity of the vehicle 1 through which the vehicle 1 can safely and smoothly travel along the planned path given the motion characteristics of the vehicle 1.

The path following is processing of planning an operation for safe and accurate traveling on a path planned by the path planning within a planned time. For example, the action planning unit 62 can calculate a target speed and a target angular velocity of the vehicle 1 based on a result of this path following processing.

The operation control unit 63 controls the operation of the vehicle 1 in order to achieve the action plan created by the action planning unit 62.

For example, the operation control unit 63 controls a steering control unit 81, a brake control unit 82, and a drive control unit 83 included in the vehicle control unit 32 to be described later, to perform lateral vehicle motion control and longitudinal vehicle motion control such that the vehicle 1 travels on the trajectory calculated by the trajectory planning. For example, the operation control unit 63 performs control for the purpose of: driver assistance functions such as collision avoidance or impact mitigation, inter-vehicle distance control, vehicle speed control, vehicle collision warning, and lane departure warning; and driving automation for traveling without operation of a driver or a remote driver.

The DMS 30 performs authentication processing of the driver, recognition processing of the state of the driver, and/or the like based on sensor data from the in-vehicle sensor 26, input data input to the HMI 31 to be described later, and/or the like. Examples of the state of the driver to be recognized include a physical condition, an arousal level, a concentration level, a fatigue level, a line-of-sight direction, a drunkenness level, a driving operation, a posture, and the like.

It is noted that the DMS 30 may perform authentication processing of a user other than the driver and recognition processing of the state of the user. Further, the DMS 30 may perform recognition processing of a situation inside the vehicle based on sensor data from the in-vehicle sensor 26. Examples of the situation inside the vehicle to be recognized include a temperature, a humidity, brightness, odor, and the like.

The HMI 31 receives various types of data, instructions, and the like as an input and presents various types of data to a user.

The data input to the HMI 31 will be schematically described. The HMI 31 includes an input device used by a person to input data. The HMI 31 generates an input signal based on the data, instruction, and/or the like input by the input device, and supplies the input signal to the respective units of the vehicle control system 11. The HMI 31 includes, for example, an operation element such as a touch panel, a button, a switch, and/or a lever as the input device. The HMI 31 is not limited thereto and may further include an input device that enables information to be input by a method other than a manual operation, such as voice, gesture, and/or the like. In addition, the HMI 31 may use, for example, a remote control device that uses infrared rays or radio waves and/or an external connection device such as a mobile device and a wearable device adaptive to the operation of the vehicle control system 11, as an input device.

Presentation of data by the HMI 31 will be schematically described. The HMI 31 generates visual information, auditory information, and tactile information for the user or for the outside of the vehicle. Furthermore, the HMI 31 performs output control for controlling an output, an output content, an output timing, an output method, and/or the like for each piece of generated information. As the visual information, the HMI 31 generates and outputs, for example, an operation screen, a state display of the vehicle 1, a warning display, an image such as a monitor image indicating a situation around the vehicle 1, and information indicated by light. Further, as the auditory information, the HMI 31 generates and outputs, for example, information indicated by sound, such as voice guidance, a warning sound, and a warning message. Furthermore, as the tactile information, the HMI 31 generates and outputs, for example, information given to the tactile sense of a user by force, vibration, movement, and/or the like.

As the output device to which the HMI 31 outputs the visual information, for example, a display device that presents the visual information by displaying an image by itself and/or a projector device that presents the visual information by projecting an image can be applied. It is noted that the display device may be, for example, a head-up display, a transmissive display, or a display having an AR (Augmented Reality) function, in addition to the display device including a normal display. The display device may alternatively be a device that displays visual information in the field of view of a user, such as a wearable device having the AR function. The wearable device includes a glasses-type display, a smartphone, a smart watch, and the like. In addition, a display device included in a navigation device, an instrument panel, a CMS (Camera Monitoring System), an electronic mirror, a lamp, and/or the like provided in the vehicle 1 can also be used as the output device to which the HMI 31 outputs visual information. Furthermore, a retrofit display device such as an on-dash monitor, a tablet terminal, a drive recorder, and a display for a drive recorder can also be used as the output device to which the HMI 131 outputs visual information.

The output device to which the auditory information is output is provided on a front surface of a dashboard in front of the driver's seat or a passenger's seat, in a console provided between the driver's seat and the passenger's seat, on a windshield, a steering wheel, a back surface of the driver's seat or the passenger's seat, and/or the like.

As the output device to which the HMI 31 outputs the auditory information, for example, an audio speaker, a headphone, and/or an earphone can be applied.

As the output device to which the HMI 31 outputs the tactile information, for example, a haptic element that uses a haptic technology can be applied. The haptic element is provided at, for example, a portion where the user touches, such as a steering wheel or a seat. It is noted that the tactile information may be output by a smartphone, a smartwatch, and/or the like carried by the user.

The vehicle control unit 32 controls the respective units of the vehicle 1. The vehicle control unit 32 includes the steering control unit 81, the brake control unit 82, the drive control unit 83, a body system control unit 84, a light control unit 85, and a horn control unit 86.

The steering control unit 81 performs detection, control, and/or the like of the state of the steering system of the vehicle 1. The steering system includes, for example, a steering mechanism including a steering wheel and the like, an electric power steering, and/or the like. The steering control unit 81 includes, for example, a steering ECU that controls the steering system, an actuator that drives the steering system, and/or the like.

The brake control unit 82 performs detection, control, and/or the like of the state of the brake system of the vehicle 1. The brake system includes, for example, a brake mechanism including a brake pedal and the like, an ABS (Antilock Brake System), a regenerative brake mechanism, and/or the like. The brake control unit 82 includes, for example, a brake ECU that controls the brake system, an actuator that drives the brake system, and/or the like.

The drive control unit 83 performs detection, control, and/or the like of the state of the drive system of the vehicle 1. The drive system includes, for example, an accelerator pedal, a driving force generation device for generating a driving force for an internal combustion engine, a driving motor, or the like, a driving force transmission mechanism for transmitting the driving force to the wheels, and/or the like. The drive control unit 83 includes, for example, a drive ECU that controls the drive system, an actuator that drives the drive system, and/or the like.

The body system control unit 84 performs detection, control, and/or the like of the state of the body system of the vehicle 1. The body system includes, for example, a keyless entry system, a smart key system, a power window device, a power seat, an air conditioner, an airbag, a seat belt, a shift lever, and/or the like. The body system control unit 84 includes, for example, a body system ECU that controls the body system, an actuator that drives the body system, and/or the like.

The light control unit 85 performs detection, control, and/or the like of the states of various lights of the vehicle 1. Examples of the light to be controlled by the light control unit 85 include a headlight, a backlight, a fog light, a turn signal, a brake light, a projector light, a display of a bumper, and the like. The light control unit 85 includes a light ECU that controls a light, an actuator that drives the light, and/or the like.

The horn control unit 86 performs detection, control, and/or the like of the state of the car horn of the vehicle 1. The horn control unit 86 includes, for example, a horn ECU that controls the car horn, an actuator that drives the car horn, and/or the like.

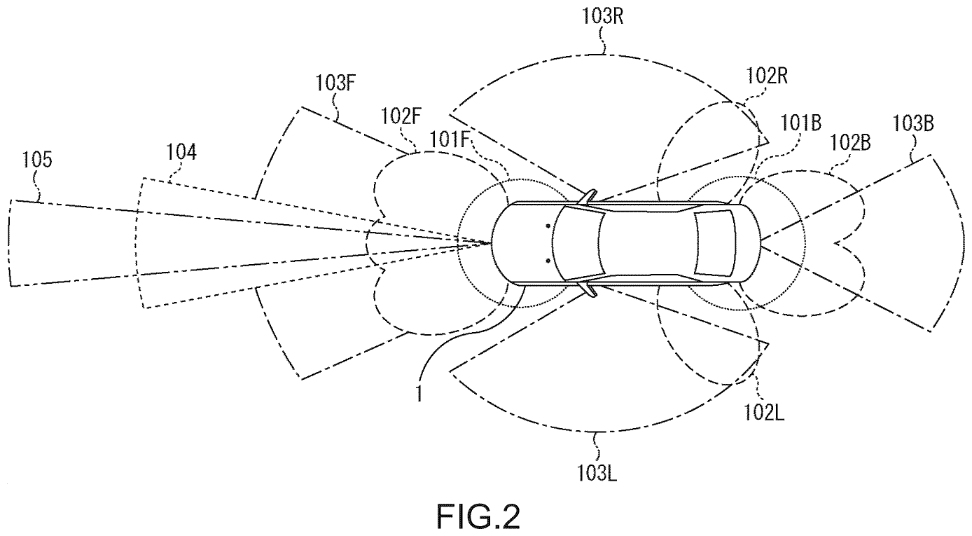

FIG. 2 is a diagram showing an example of sensing areas of the camera 51, the radar 52, the LiDAR 53, the ultrasonic sensor 54, and the like of the external recognition sensor 25 in FIG. 1. It is noted that FIG. 2 schematically shows the vehicle 1 as viewed from above, with the left end side being the front end (front) side of the vehicle 1 and the right end side being the rear end (rear) side of the vehicle 1.

A sensing area 101F and a sensing area 101B are examples of the sensing areas of the ultrasonic sensor 54. The sensing area 101F covers the periphery of the front end of the vehicle 1 by the plurality of the ultrasonic sensors 54. The sensing area 101B covers the periphery of the rear end of the vehicle 1 by the plurality of the ultrasonic sensors 54.

The sensing results in the sensing area 101F and the sensing area 101B are used in, for example, parking assistance of the vehicle 1, and the like.

A sensing area 102F, a sensing area 102B, a sensing area 102L, and a sensing area 102R indicate examples of sensing areas of the radar 52 for a short distance or a middle distance. The sensing area 102F covers a position farther than the sensing area 101F in front of the vehicle 1. The sensing area 102B covers a position farther than the sensing area 101B behind the vehicle 1. The sensing area 102L covers the rear periphery of the left side of the vehicle 1. The sensing area 102R covers the rear periphery of the right side of the vehicle 1.

The sensing result in the sensing area 102F is used in, for example, detection or the like of a vehicle, a pedestrian, or the like that is present on the front side of the vehicle 1. The sensing result in the sensing area 102B is used in, for example, a collision prevention function or the like on the rear side of the vehicle 1. The sensing results in the sensing area 102L and the sensing area 102R are used in, for example, detection or the like of an object in blind spots on sides of the vehicle 1.

A sensing area 103F, a sensing area 103B, a sensing area 103L, and a sensing area 103R indicate examples of sensing areas of the camera 51. The sensing area 103F covers a position farther than the sensing area 102F in front of the vehicle 1. The sensing area 103B covers a position farther than the sensing area 102B behind the vehicle 1. The sensing area 103L covers the periphery of the left side of the vehicle 1. The sensing area 103R covers the periphery of the right side of the vehicle 1.

The sensing result in the sensing area 103F can be used in, for example, recognition of a traffic light and/or a traffic sign, a lane departure prevention assist system, and/or an automatic headlight control system. The sensing result in the sensing area 103B can be used in, for example, parking assistance and/or a surround view system. The sensing results in the sensing area 103L and the sensing area 103R can be used in, for example, a surround view system.

A sensing area 104 indicates an example of a sensing area of the LiDAR 53. The sensing area 104 covers a position farther than the sensing area 103F in front of the vehicle 1. On the other hand, the sensing area 104 has a narrower range in the left-right direction than the sensing area 103F.

The sensing result in the sensing area 104 is used in, for example, detecting an object such as a peripheral vehicle.

A sensing area 105 indicates an example of the sensing area of the radar 52 for a long distance. The sensing area 105 covers a position farther than the sensing area 104 in front of the vehicle 1. On the other hand, the sensing area 105 has a narrower range in the left-right direction than the sensing area 104.

The sensing result in the sensing area 105 is used in, for example, ACC (Adaptive Cruise Control), emergency braking, collision avoidance, and/or the like.

It is noted that the sensing areas of the sensors including the cameras 51, the radar 52, the LiDAR 53, and the ultrasonic sensor 54 included in the external recognition sensor 25 may take various configurations other than those shown in FIG. 2. Specifically, the ultrasonic sensors 54 may also sense the sides of the vehicle 1, and the LiDAR 53 may sense the rear of the vehicle 1. The installation positions of the sensors are not limited to the examples described above. In addition, the number of sensors may be one or more.

### 2. Embodiment

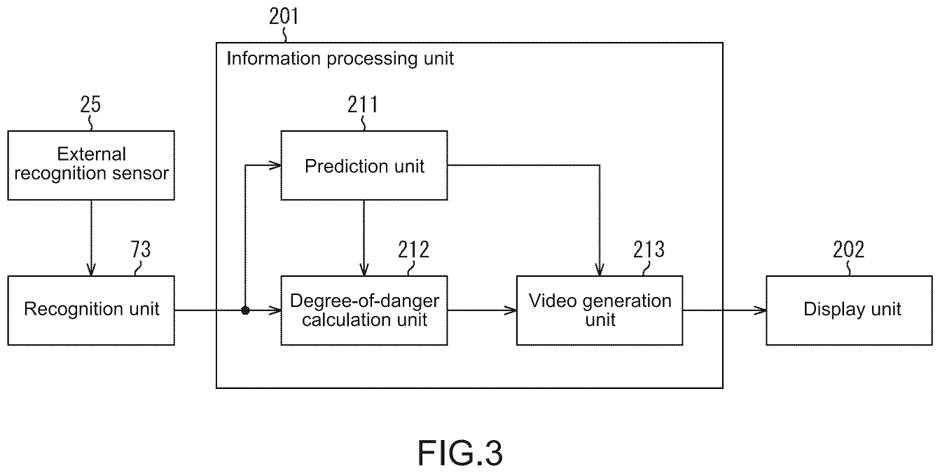

Next, an embodiment of the present technology will be described with reference to FIGS. 3 to 10.

FIG. 3 is a block diagram showing a configuration example of the vehicle control system 11 to which the present technology is applied.

The vehicle control system 11 shown in FIG. 3 includes, as well as the configuration described above (the external recognition sensor 25 and the recognition unit 73), an information processing unit 201 that calculates the degree of danger of an object around the vehicle 1 and generates danger prediction information indicating the degree of danger of the object, and a display unit 202 that displays the danger prediction information. It is noted that FIG. 3 shows a configuration of a portion of the vehicle control system 11 that is related to the display of the danger prediction information.

As described above, the recognition unit 73 acquires sensor data from the external recognition sensor 25, and performs the recognition processing of an object around the vehicle 1 based on the sensor data using AI (Artificial Intelligence) learned by using deep learning or other machine learning, a neural network, and/or the like. The recognition unit 73 recognizes, for example, the type, the attribute, the state, the position, the orientation, the movement speed, and the size of an object around the vehicle 1 by the recognition processing.

The type of object indicates whether the object is a pedestrian, a vehicle, a ball, a guardrail, a road sign, an obstacle, or the like. The recognition unit 73 recognizes not only the moving objects such as a pedestrian, a vehicle, and a ball, but also stationary objects such as a guardrail, a sign, and an obstacle.

When the type of object is a pedestrian, the attribute of the object indicates whether the pedestrian is a child, an elderly person, and/or the like. When the type of object is a vehicle, the attribute of the object indicates a type, color, and/or the like of the vehicle. The state of the object indicates a state where a pedestrian corresponding to an object is walking while looking at a smartphone, a state where the brake light of the vehicle as an object is on, and/or the like.

The recognition unit 73 supplies the recognition result of the object around the vehicle 1 to the information processing unit 201. It is noted that the recognition unit 73 may acquire information related to the object around the vehicle 1 from equipment other than the vehicle 1 via the communication unit 22, and perform the recognition processing based on that information.

The information processing unit 201 is a part of the function of the HMI 31. The information processing unit 201 includes a prediction unit 211, a degree-of-danger calculation unit 212, and a video generation unit 213.

The prediction unit 211 predicts a future movement of an object around the vehicle 1 and a movement of the object in a case where an accident occurs, based on the recognition result of the object obtained by the recognition unit 73.

Specifically, the prediction unit 211 predicts a range that the object will reach in a few seconds as the future movement of the object. The range that the object will reach in a few seconds is basically predicted based on the position, the orientation, and the movement speed of the object.

It is noted that the range that the object will reach in a few seconds may alternatively be predicted based on the movement of the object in time series. For example, the range that the object will reach in a few seconds is predicted based on the movement amount of the object during a most-recent predetermined period. Alternatively, the range that the object will reach in a few seconds may be predicted in consideration of the state of the object, such as a state where a pedestrian is walking while looking at a smartphone or a state where a brake light of a vehicle is on.

For example, the prediction unit 211 predicts the possibility of an accident occurring and the movement of an object in a case where an accident occurs (the range that the object will reach in a few seconds), based on the attribute of the object such as “children are highly likely to suddenly run out onto the road” or “elderly people are highly likely to fall over while crossing the road”. The prediction unit 211 can also predict the possibility of an accident occurring and the movement of an object in a case where an accident occurs, in consideration of a position of a stationary object, such as “children are unlikely to suddenly run out onto the road because of the guardrail”.

The prediction unit 211 supplies movement information indicating the future movement of the object and accident information indicating the movement of the object in a case where an accident occurs to the degree-of-danger calculation unit 212 and the video generation unit 213. The accident information includes information indicating the possibility of an accident occurring. The accident information may alternatively include prediction difficulty, which is a degree of difficulty in predicting the future movement of the object.

The degree-of-danger calculation unit 212 calculates the degree of danger of the object based on the recognition result of the object obtained by the recognition unit 73 and the movement information and accident information supplied from the prediction unit 211. For example, the possibility of a collision between the object and the vehicle 1 is estimated as the degree of danger based on the range that the object is predicted to reach in a few seconds and the movement direction and movement speed of the vehicle 1.

The degree-of-danger calculation unit 212 supplies the degree of danger of the object to the video generation unit 213.

The video generation unit 213 generates danger prediction information based on the movement information and accident information supplied from the prediction unit 211 and the degree of danger of the object supplied from the degree-of-danger calculation unit 212. Specifically, the video generation unit 213 controls a display mode of the danger prediction information based on at least one of the movement information, the accident information, or the degree of danger. The display mode of the danger prediction information includes the color, shape (width, inclination of sides, direction), transparency, and/or the like.

The video generation unit 213 generates a video including the danger prediction information. For example, the video generation unit 213 superimposes the danger prediction information on a captured video showing the surroundings of the vehicle 1. The video generation unit 213 functions as a presentation control unit that controls the display unit 202 to present a video to the user of the vehicle 1.

The display unit 202 includes, for example, a display installed inside the vehicle. The display unit 202 displays a video under control of the video generation unit 213, and presents the danger prediction information to the user of the vehicle 1.

All or some of the functions of the recognition unit 73 and the information processing unit 201 may be provided in a device other than the vehicle 1, such as a cloud.

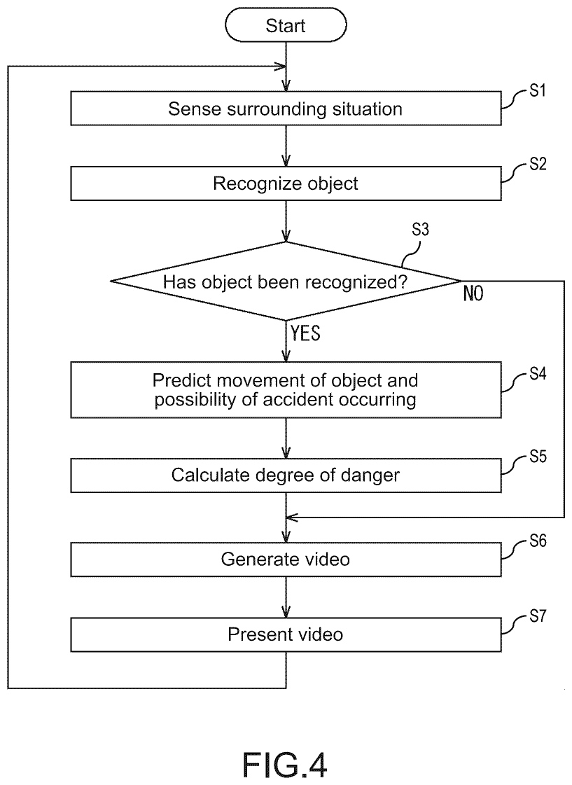

Next, processing performed by the vehicle control system 11 having the configuration as described above will be described with reference to the flowchart shown in FIG. 4. For example, the processing shown in FIG. 4 is started when an operation for activating the vehicle 1 to start driving is performed, that is, for example, when an ignition switch, a power switch, a start switch, or the like of the vehicle 1 is turned on. Further, for example, the processing shown in FIG. 4 is ended when an operation for ending the driving of the vehicle 1 is performed, that is, for example, when the ignition switch, the power switch, the start switch, or the like of the vehicle 1 is turned off.

In Step S1, the external recognition sensor 25 senses a situation around the vehicle 1.

In Step S2, the recognition unit 73 recognizes an object around the vehicle 1 based on the sensor data of the external recognition sensor.

In Step S3, the information processing unit 201 determines whether the recognition unit 73 has recognized an object.

When it is determined in Step S3 that an object has been recognized, the processing proceeds to Step S4. In Step S4, the prediction unit 211 predicts a future movement of the object recognized by the recognition unit 73 and the possibility of an accident occurring.

In Step S5, the degree-of-danger calculation unit 212 calculates the degree of danger of the object recognized by the recognition unit 73 based on the recognition result obtained by the recognition unit 73 and the prediction result obtained by the prediction unit 211.

After the degree of danger of the object is calculated in Step S5, the processing proceeds to Step S6. On the other hand, when it is determined in Step S3 that an object has not been recognized, the processing of Steps S4 and S5 is skipped, and the processing proceeds to Step S6.

In Step S6, the video generation unit 213 generates a video to be presented to the user of the vehicle 1 by the display unit 202. When an object is recognized by the recognition unit 73, the video generation unit 213 generates a video to be presented by the display unit 202 by, for example, superimposing danger prediction information on a captured video showing the surroundings of the vehicle 1. When an object is not recognized by the recognition unit 73, the video generation unit 213 uses the captured video showing the surroundings of the vehicle 1 as it is as the video to be presented by the display unit 202, for example.

In Step S7, the display unit 202 presents the video to the user of the vehicle 1 under control of the video generation unit 213.

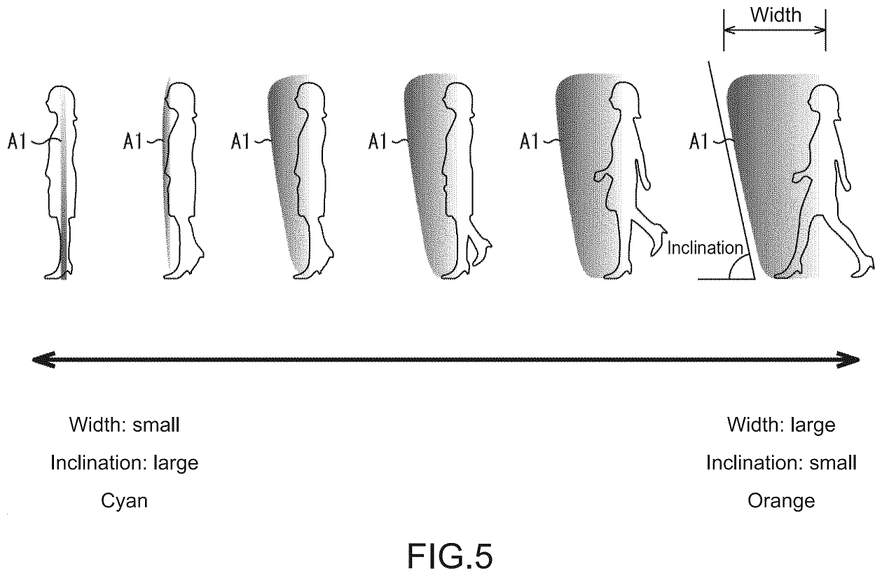

FIG. 5 is a diagram showing an example of the danger prediction information.

As shown in FIG. 5, when a pedestrian corresponding to an object is standing still or is predicted to come to a standstill, the danger prediction information A1 has, for example, a square shape with long sides connecting a head and feet of the pedestrian. Also, as shown in FIG. 5, when the pedestrian is moving or is predicted to move, the danger prediction information A1 has, for example, a trapezoid shape with rounded corners and sides connecting the head and feet of the pedestrian.

The danger prediction information A1 has a bulging shape at an upper portion of the side thereof on the movement direction side (left side) in which the pedestrian is predicted to move, and the side of the danger prediction information A1 on the movement direction side bulges more as the range that the pedestrian is predicted to reach in a few seconds becomes larger.

In other words, the width (the length of the upper side) of the danger prediction information A1 indicates the magnitude of the future movement of the pedestrian. Further, the direction of the bulge of the danger prediction information A1 indicates the predicted movement direction of the pedestrian. Furthermore, the outer angle of the vertex (the inclination of the side on the side of the predicted movement direction of the pedestrian) on the lower side of the danger prediction information A1 in the predicted movement direction of the pedestrian (lower left side) also indicates the magnitude of the future movement of the pedestrian.

The color of the danger prediction information A1 indicates the degree of danger of the pedestrian. When the degree of danger is low, the danger prediction information A1 is displayed in, for example, cyan, and when the degree of danger is medium, the danger prediction information A1 is displayed in, for example, yellow. When the degree of danger is high, the danger prediction information A1 is displayed in, for example, orange. The danger prediction information A1 is given a gradation such that the transparency increases as it gets closer to the pedestrian, for example.

It is noted that the width of the danger prediction information A1 or the inclination of the side of the danger prediction information A1 on the side of the predicted movement direction of the pedestrian may indicate information other than the magnitude of the future movement of the pedestrian. For example, the width of the danger prediction information A1 may indicate an amplitude of the future movement of the pedestrian. For example, the position of the side of the danger prediction information A1 on the side of the predicted movement direction of the pedestrian indicates an upper limit of the range that the pedestrian may reach in a few seconds, and the position of the side opposite to the predicted movement direction of the pedestrian indicates a lower limit of the range.

In addition, the width of the danger prediction information A1 may indicate, for example, the degree of danger of the pedestrian. The inclination of the side of the danger prediction information A1 on the side of the predicted movement direction of the pedestrian may indicate the predicted movement speed of the pedestrian.

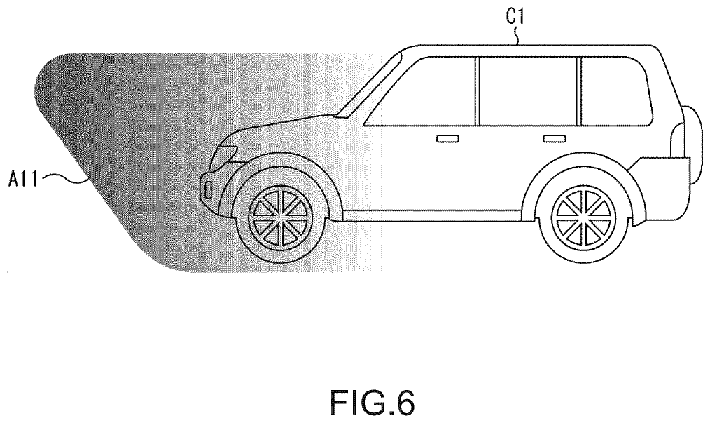

FIG. 6 is a diagram showing an example of the danger prediction information indicating a degree of danger of a traveling vehicle.

When it is predicted that the vehicle C1 will travel to the left at a high speed and the traveling of the vehicle 1 will be blocked, for example, the vehicle control system 11 calculates a high degree of danger for the vehicle C1, and superimposes danger prediction information A11 indicating the degree of danger of the vehicle C1 on a portion of the vehicle C1 and displays it in orange as shown in FIG. 6. Since the vehicle C1 is predicted to travel at a high speed, the vehicle control system 11 increases the width of the danger prediction information A11 and reduces the inclination of the side of the danger prediction information A11 on the left side, for example.

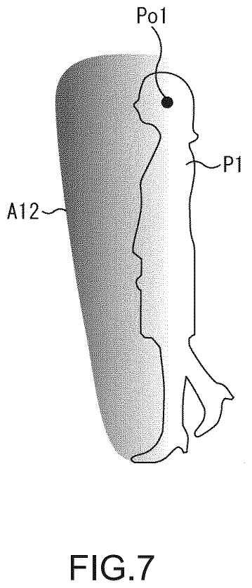

FIG. 7 is a diagram showing an example of the danger prediction information indicating a degree of danger of a pedestrian crossing a crosswalk.

When the pedestrian P1 is predicted to cross the crosswalk and move in the left direction, the vehicle control system 11 calculates a medium degree of danger for the pedestrian P1, for example, and superimposes danger prediction information A12 indicating the degree of danger of the pedestrian P1 on a portion of the pedestrian P1 and displays it in yellow, as shown in FIG. 7. Since the pedestrian P1 is predicted to move at a low speed, the vehicle control system 11 reduces the width of the danger prediction information A12 and increases the inclination of the side of the danger prediction information A12 on the left side, for example.

It is noted that as shown in FIG. 7, a point Po1 may be displayed in a state of being superimposed on a head of the pedestrian P1. By displaying the point Po1, the presence of the pedestrian is likely to be recognized by the user of the vehicle 1. If the presence of the pedestrian P1 around the vehicle 1 is recognized, but the orientation of the pedestrian P1 is not recognized, or the future movement of the pedestrian P1 is not predictable, only the point Po1 may be displayed without displaying the danger prediction information A12.

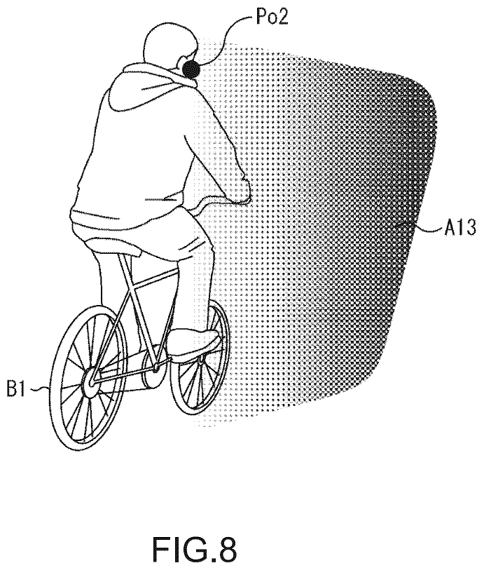

FIG. 8 is a diagram showing an example of the danger prediction information indicating a degree of danger of a bicycle.

When the bicycle B1 is predicted to suddenly come to the right and cross in front of the vehicle 1, the vehicle control system 11 calculates a high degree of danger for the bicycle B1, for example, and superimposes danger prediction information A13 indicating the degree of danger of the bicycle on a portion of the bicycle and displays it in orange, as shown in FIG. 8.

Since the bicycle B1 is predicted to move at a high speed with respect to the vehicle C1, the vehicle control system 11 increases the width of the danger prediction information A13 and reduces the inclination of the side of the danger prediction information A13 on the right side, for example. Since the bicycle B1 is predicted to move in the rear right direction (the right front of the vehicle 1), the danger prediction information A13 is drawn in perspective so that the user of the vehicle 1 can easily recognize that the bicycle B1 is moving in the rear right direction.

It is noted that as shown in FIG. 8, a point Po2 may be displayed in a state of being superimposed on a head of a person riding the bicycle B1.

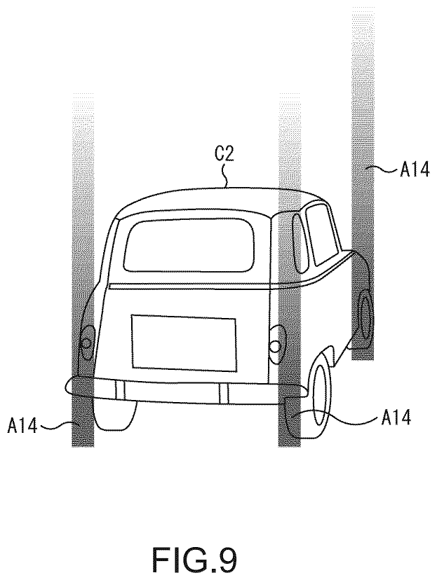

FIG. 9 is a diagram showing an example of the danger prediction information indicating a degree of danger of a vehicle at a stop.

When it is predicted that the vehicle C2 is stopped at a location that does not hinder the traveling of the vehicle 1, the vehicle control system 11 calculates a low degree of danger for the vehicle C2, for example, and displays danger prediction information A14 indicating the degree of danger of the vehicle C2 in cyan, as shown in FIG. 9.

The degree of danger of a vehicle at a stop or a stationary obstacle is indicated by, for example, columnar danger prediction information arranged at corners of a bounding box surrounding a bottom surface of the vehicle or obstacle.

The danger prediction information as described above may be superimposed on a captured video showing the surroundings of vehicle 1 to be displayed on a display installed inside vehicle 1, or may be displayed on a head-up display so as to be superimposed on a real object.

It is noted that the display mode of the danger prediction information is not limited to the display modes described with reference to FIGS. 5 to 9.

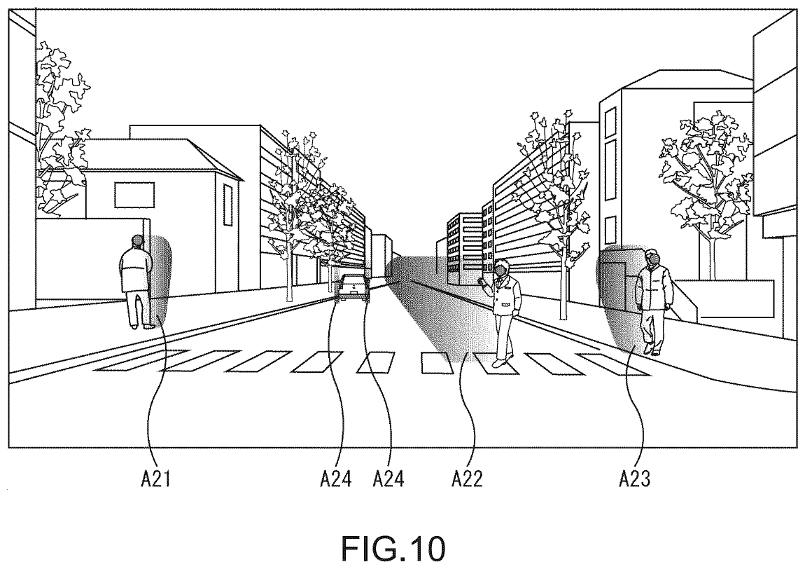

FIG. 10 is a diagram showing a display example of the danger prediction information.

In the example shown in FIG. 10, danger prediction information A21 to A24 are displayed in a state of being superimposed on a captured video showing the surroundings of the vehicle 1. The danger prediction information A21 indicates the degree of danger of a pedestrian moving in the rear direction as viewed from the user of the vehicle 1, and the danger prediction information A22 indicates the degree of danger of a pedestrian crossing a crosswalk. The danger prediction information A23 indicates the degree of danger of a pedestrian who is about to cross the crosswalk, and the danger prediction information A24 indicates the degree of danger of a vehicle stopped on the road.

It is noted that since presenting an excessive amount of danger prediction information to the user of the vehicle 1 may confuse the user, when there are a large number of objects around vehicle 1, only the danger prediction information indicating the degree of danger higher than a predetermined threshold value may be presented.

As described above, in the vehicle control system 11 according to the present technology, the movement information indicating a future movement of an object around the vehicle 1 and the accident information indicating a movement of the object in a case where an accident occurs are predicted, the degree of danger of the object is calculated based on the movement information and the accident information, and the danger prediction information indicating the degree of danger of the object is presented to the user of the vehicle 1.

The vehicle control system 11 does not simply warn that a dangerous object has been recognized, but visually presents which object is moving in what direction and how dangerous each object is. Therefore, the vehicle control system 11 can favorably present information for avoiding danger to the user of the vehicle 1. This allows the user of the vehicle 1 to intuitively grasp the potential danger, and the vehicle control system 11 can realize safe driving of the vehicle 1.

### 3. Modified Examples

### Variations of Danger Prediction Information

The descriptions above have been given on the example where the range that an object is predicted to reach in a few seconds is indicated by planar danger prediction information. In cases where there is a possibility of an accident occurring, such as an elderly person suddenly falling over or a child suddenly changing the movement direction, it may be difficult for the planar danger prediction information to simultaneously express the range in which an object is predicted to move at normal times and the range in which the object is predicted to move in a case where an accident occurs. In this regard, the range that an object is predicted to reach in a few seconds may be indicated by three-dimensional danger prediction information.

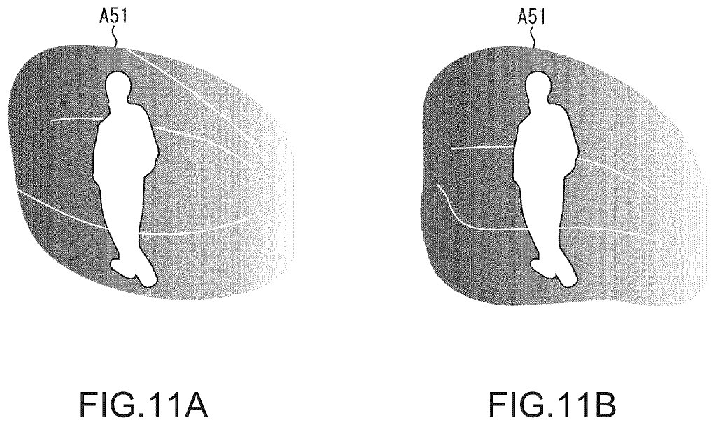

FIG. 11 is a diagram showing a first modified example of the danger prediction information.

As shown in A of FIG. 11, the shape of the danger prediction information A51 is substantially spherical so as to encompass the entire pedestrian corresponding to an object, and a gradation is applied to the danger prediction information A51 such that the transparency gradually increases from the front direction to the back direction of the pedestrian.

When the pedestrian is highly likely to suddenly move in the left direction as viewed from the pedestrian instead of the front direction, the possibility of the pedestrian suddenly moving in the left direction is expressed by, for example, causing a part of the spherical surface of the danger prediction information A51 in the left direction as viewed from the pedestrian to bulge as shown in B of FIG. 11.

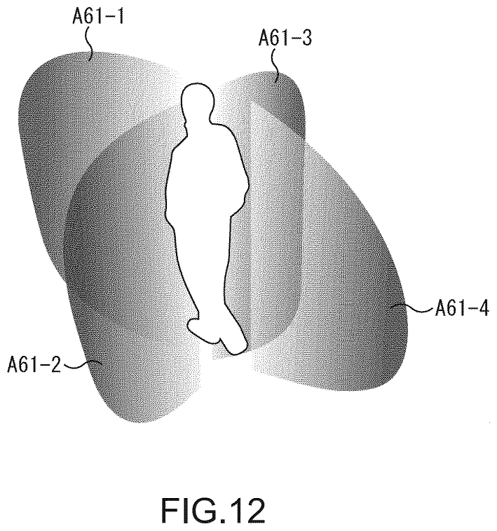

FIG. 12 is a diagram showing a second modified example of the danger prediction information.

A plurality of pieces of planar danger prediction information respectively corresponding to movement directions of a plurality of movement directions in which one object is predicted to move may be displayed. In the example of FIG. 12, four pieces of danger prediction information A61-1 to A61-4 are superimposed on one pedestrian. The danger prediction information A61-1 indicates a range in the front direction that the pedestrian is predicted to reach in a few seconds, and the danger prediction information A61-2 indicates a range in the left direction that the pedestrian is predicted to reach in a few seconds. The danger prediction information A61-3 indicates a range in the right direction that the pedestrian is predicted to reach in a few seconds, and the danger prediction information A61-4 indicates a range in the back direction that the pedestrian is predicted to reach in a few seconds.

The danger prediction information A61-1 to A61-4 may be displayed in one color according to the degree of danger of the pedestrian. Alternatively, each of the danger prediction information A61-1 to A61-4 may be displayed in a color corresponding to the degree of danger in a case where the pedestrian moves in the corresponding one of the front, rear, left, and right directions.

### Example of Securing Visibility

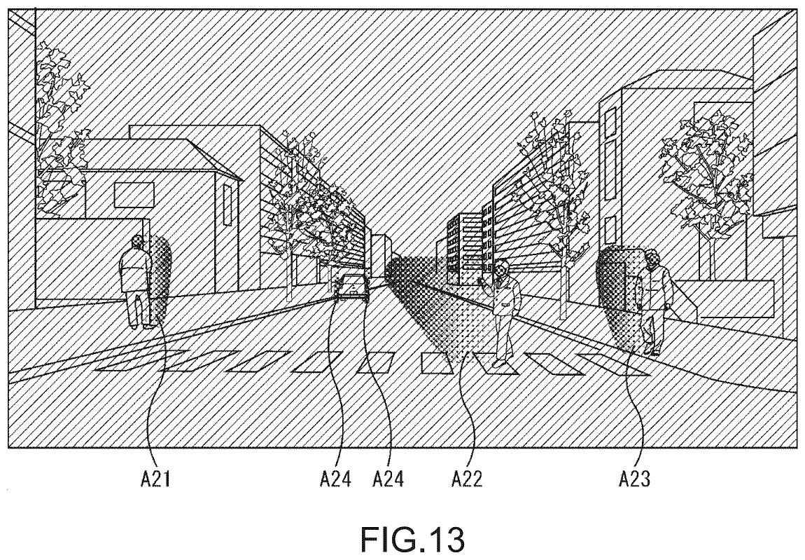

FIG. 13 is a diagram showing a display example of the danger prediction information for securing visibility of the danger prediction information.

As hatched in FIG. 13, image processing may be performed to lower the brightness or chroma of the entire captured video showing the surroundings of the vehicle 1, and danger prediction information A21 to A24 may be superimposed on this video.

The danger prediction information may become difficult to be seen when the danger prediction information is superimposed on an unprocessed captured video showing the surroundings of the vehicle 1. By lowering the brightness or chroma of the captured video, it is possible to secure visibility of the danger prediction information.

It is noted that the image processing for lowering the brightness or chroma may be applied to the entire captured video, or may be applied only to the periphery of the portion of the captured video where the danger prediction information is superimposed.

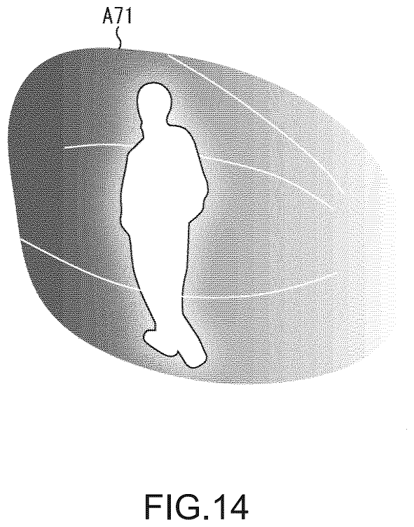

FIG. 14 is a diagram showing a display example of the danger prediction information for securing visibility of an object.

When the danger prediction information A71 is displayed so as to encompass the entire object, the transparency of the area along the outline of the object in the danger prediction information A71 may be increased as shown in FIG. 14. When the danger prediction information is superimposed on the object, the object itself may become difficult to be seen. By increasing the transparency of a portion in the periphery of the object in the danger prediction information, it becomes possible to secure visibility of the object on which the danger prediction information is superimposed.

When planar danger prediction information is displayed, in order to secure visibility of the object, it is favorable to superimpose the danger prediction information not directly on the object, but at a position slightly deviated from the object, such as around the object.

### Example That Considers Traveling Environment

The future movement of an object and the possibility of an accident occurring may be predicted based on not only the type, the attribute, the state, the position, the orientation, the movement speed, and the size of the object, but also a traveling environment of the vehicle 1. Further, the degree of danger of the object may also be calculated based on the traveling environment of the vehicle 1.

The traveling environment of the vehicle 1 includes the location, time of day, weather, and the like. For example, in a school zone, there is a good possibility that children will run out onto the road. In a rainy weather or during snowfall, a braking distance of the vehicle 1 when putting on the brake becomes long. Also in a rainy weather or during snowfall, there is a good possibility that pedestrians will fall over. In this manner, the prediction of the future movement of an object and the possibility of an accident occurring and the calculation of the degree of danger of an object are performed in consideration of the traveling environment of the vehicle 1.

It is noted that when the vehicle 1 is traveling in a traveling environment where the degree of danger of an object becomes higher than that at normal times, the danger prediction information may be displayed with emphasis as compared to a case where the vehicle 1 is traveling in a normal traveling environment. Alternatively, dangerous environment information indicating a degree of danger of the traveling environment may be displayed.

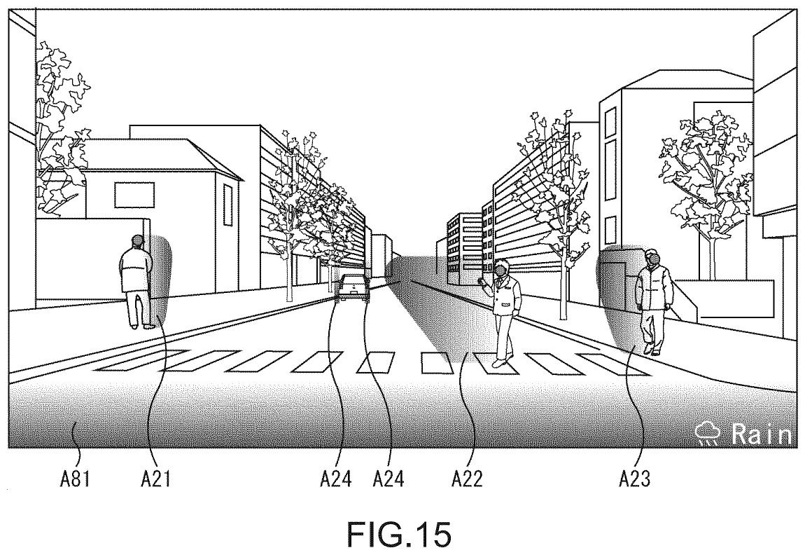

FIG. 15 is a diagram showing an example of the dangerous environment information.

For example, when the road surface is wet by rain, dangerous environment information A81 indicating in color that the degree of danger of the road surface is high is displayed in a state of being superimposed on a portion of the road surface as shown in FIG. 15. When the degree of danger is high, the dangerous environment information A81 is displayed in orange, for example.

By displaying an icon and text indicating that it is raining at a lower right corner of the screen of the display unit 202 along with the dangerous environment information A81, for example, the user of the vehicle 1 is reminded that the possibility of an accident occurring is high since the road surface is wet.

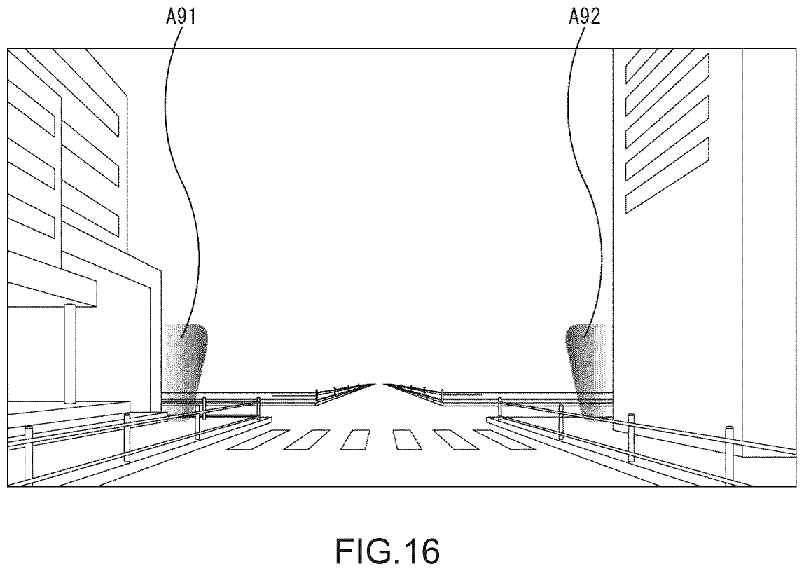

FIG. 16 is a diagram showing another example of the dangerous environment information.

When there are places that are blind spots, such as a back side of a building, around the vehicle 1 as viewed from the user of the vehicle 1, pieces of dangerous environment information A91 and A92 are displayed in a state of being superimposed on the places that are blind spots as shown in FIG. 16. In the pieces of dangerous environment information A91 and A92, for example, when a pedestrian runs out from the place that is a blind spot, the range that the pedestrian is predicted to reach in a few seconds is indicated by the width, and the degree of danger of the pedestrian is indicated by the color.

In this manner, at places with poor visibility such as intersections, even if an actual pedestrian, vehicle, or the like is not recognized, it is possible to display the dangerous environment information to alert the user of vehicle 1.

### Others

The present technology can be applied to various products. For example, the present technology may be realized as a device mounted on any type of moving body such as an automobile, an electric vehicle, a hybrid electric vehicle, a motorcycle, a bicycle, a personal mobility, an airplane, a drone, a ship, or a robot.

### Regarding Computer

The series of processing described above can be executed by hardware or can be executed by software. When the series of processing is executed by software, a program configuring the software is installed in a computer incorporated into dedicated hardware, a general-purpose personal computer, and/or the like from a medium having the program recorded thereon.

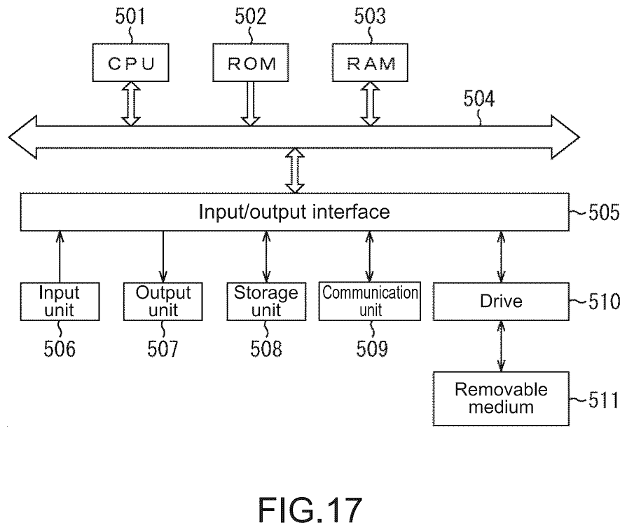

FIG. 17 is a block diagram showing a hardware configuration example of a computer that executes the series of processing described above by a program. The information processing unit 201 includes, for example, a PC having a configuration similar to the configuration shown in FIG. 17.

A CPU 501, a ROM (Read Only Memory) 502, and a RAM 503 are mutually connected via a bus 504.

An input/output interface 505 is also connected to the bus 504. Connected to the input/output interface 505 are an input unit 506 that includes a keyboard, a mouse, and/or the like, and an output unit 507 that includes a display, a speaker, and/or the like. Also connected to the input/output interface 505 are a storage unit 508 that includes a hard disk, a nonvolatile memory, and/or the like, a communication unit 509 that includes a network interface and/or the like, and a drive 510 that drives a removable medium 511.

In the computer configured as described above, the CPU 501 loads a program stored in the storage unit 508 into the RAM 503 via the input/output interface 505 and the bus 504 and executes it, to carry out the series of processing described above, for example.

The program to be executed by the CPU 501 is, for example, recorded onto the removable medium 511 or is provided via wired or wireless transmission media such as a local area network, the Internet, and digital broadcasting, to be installed in the storage unit 508.

It is noted that the program to be executed by the computer may be a program in which the processing is executed in time series in the order described in the present specification, or may be a program in which the processing is executed in parallel or at necessary timings such as when invoked.

In the present specification, the system refers to an aggregation of a plurality of constituent elements (apparatuses, modules (components), and the like), and whether all of the constituent elements are within the same housing is irrelevant. Accordingly, a plurality of apparatuses respectively housed in separate housings and connected to each other via a network and a single apparatus in which a plurality of modules is housed in a single housing are both systems.

The effects described in the present specification are mere examples and are not limited, and other effects may also be exerted.

Further, the embodiment of the present technology is not limited to the embodiment described above and can be variously modified without departing from the gist of the present technology.

For example, the present technology can take a configuration of cloud computing in which a single function is shared to be cooperatively processed by a plurality of apparatuses via a network.

Moreover, the respective steps described above in the flowchart can be executed by a single apparatus, or can be shared by a plurality of apparatuses to be executed.

In addition, when a plurality of processing is included in a single step, the plurality of processing included in that single step can be executed by a single apparatus, or can be shared by a plurality of apparatuses to be executed.

### Combination Example of Configurations

The present technology can also take the following configurations.

(1) An information processing apparatus, including:
a prediction unit which predicts movement information indicating a future movement of an object around a moving body and accident information indicating a movement of the object in a case where an accident occurs;
a calculation unit which calculates a degree of danger of the object on the basis of the movement information and the accident information; and
a presentation control unit which presents, to a user of the moving body, danger prediction information indicating the degree of danger of the object.
   (2) The information processing apparatus according to (1), in which
the prediction unit predicts the movement information on the basis of a position, an orientation, and a movement speed of the object.
   (3) The information processing apparatus according to (1) or (2), in which
the prediction unit predicts the movement information on the basis of the movement of the object in time series.
   (4) The information processing apparatus according to any one of (1) to (3), in which
the prediction unit predicts the accident information on the basis of an attribute of the object.
   (5) The information processing apparatus according to any one of (1) to (4), in which
the prediction unit predicts the accident information on the basis of an environment around the moving body.
   (6) The information processing apparatus according to (5), in which
the environment includes a location where the moving body moves, a time of day during which the moving body moves, and a weather.
   (7) The information processing apparatus according to any one of (1) to (6), in which
the presentation control unit displays the danger prediction information in a state of being superimposed on the object or around the object.
   (8) The information processing apparatus according to (7), in which
the presentation control unit controls a display mode of the danger prediction information on the basis of at least one of the degree of danger of the object, the movement information, or the accident information.
   (9) The information processing apparatus according to (8), in which
the presentation control unit controls a color of the danger prediction information on the basis of the degree of danger of the object.
   (10) The information processing apparatus according to (9), in which
the presentation control unit controls a shape of the danger prediction information on the basis of a movement direction in which the object is predicted to move.
   (11) The information processing apparatus according to (10), in which
the presentation control unit displays a plurality of the pieces of danger prediction information in a state of being superimposed on the object or around the object, the plurality of the pieces of danger prediction information being a plurality of the pieces of danger prediction information respectively corresponding to the movement directions of a plurality of the movement directions in which the object is predicted to move.
   (12) The information processing apparatus according to (11), in which
the calculation unit calculates the degree of danger of the object for each of the movement directions of the object, and
the presentation control unit controls the color of each of the plurality of the pieces of danger prediction information on the basis of the degree of danger of the object that is calculated for each of the movement directions.
   (13) The information processing apparatus according to any one of (8) to (12), in which
the presentation control unit controls a shape of the danger prediction information on the basis of a range in which the object is predicted to move.
   (14) The information processing apparatus according to any one of (8) to (13), in which
the presentation control unit controls an angle formed by a side of the danger prediction information, on the basis of a predicted movement speed of the object.
   (15) The information processing apparatus according to any one of (8) to (12) and (14), in which
the presentation control unit controls a shape of the danger prediction information on the basis of the degree of danger of the object.
   (16) The information processing apparatus according to any one of (1) to (15), in which
the presentation control unit presents, to the user, dangerous environment information indicating a degree of danger of an environment around the moving body.
   (17) The information processing apparatus according to any one of (1) to (16), in which
the prediction unit predicts the movement information and the accident information on the basis of sensor data of a sensor which is provided to the moving body and which senses surroundings of the moving body.
   (18) The information processing apparatus according to any one of (1) to (17), in which
the prediction unit predicts the movement information and the accident information on the basis of information related to the object that is acquired from equipment other than the moving body.
   (19) An information processing method that is performed by an information processing apparatus, the information processing method including:
predicting movement information indicating a future movement of an object around a moving body and accident information indicating a movement of the object in a case where an accident occurs;
calculating a degree of danger of the object on the basis of the movement information and the accident information; and
presenting, to a user of the moving body, danger prediction information indicating the degree of danger of the object.
   (20) A program for causing a computer to execute processing including:
predicting movement information indicating a future movement of an object around a moving body and accident information indicating a movement of the object in a case where an accident occurs;
calculating a degree of danger of the object on the basis of the movement information and the accident information; and
presenting, to a user of the moving body, danger prediction information indicating the degree of danger of the object.

### REFERENCE SIGNS LIST

1 vehicle
11 vehicle control system
25 external recognition sensor
73 recognition unit
201 information processing unit
202 display unit
211 prediction unit
212 degree-of-danger calculation unit
213 video generation unit

What is claimed is:

1. An information processing apparatus, comprising:
a prediction unit which predicts movement information indicating a future movement of an object around a moving body and accident information indicating a movement of the object in a case where an accident occurs;
a calculation unit which calculates a degree of danger of the object on a basis of the movement information and the accident information; and
a presentation control unit which presents, to a user of the moving body, danger prediction information indicating the degree of danger of the object.

2. The information processing apparatus according to claim 1, wherein
the prediction unit predicts the movement information on a basis of a position, an orientation, and a movement speed of the object.

3. The information processing apparatus according to claim 1, wherein
the prediction unit predicts the movement information on a basis of the movement of the object in time series.

4. The information processing apparatus according to claim 1, wherein
the prediction unit predicts the accident information on a basis of an attribute of the object.

5. The information processing apparatus according to claim 1, wherein
the prediction unit predicts the accident information on a basis of an environment around the moving body.

6. The information processing apparatus according to claim 5, wherein
the environment includes a location where the moving body moves, a time of day during which the moving body moves, and a weather.

7. The information processing apparatus according to claim 1, wherein
the presentation control unit displays the danger prediction information in a state of being superimposed on the object or around the object.

8. The information processing apparatus according to claim 7, wherein
the presentation control unit controls a display mode of the danger prediction information on a basis of at least one of the degree of danger of the object, the movement information, or the accident information.

9. The information processing apparatus according to claim 8, wherein
the presentation control unit controls a color of the danger prediction information on a basis of the degree of danger of the object.

10. The information processing apparatus according to claim 9, wherein
the presentation control unit controls a shape of the danger prediction information on a basis of a movement direction in which the object is predicted to move.

11. The information processing apparatus according to claim 10, wherein
the presentation control unit displays a plurality of the pieces of danger prediction information in a state of being superimposed on the object or around the object, the plurality of the pieces of danger prediction information being a plurality of the pieces of danger prediction information respectively corresponding to the movement directions of a plurality of the movement directions in which the object is predicted to move.

12. The information processing apparatus according to claim 11, wherein
the calculation unit calculates the degree of danger of the object for each of the movement directions of the object, and
the presentation control unit controls the color of each of the plurality of the pieces of danger prediction information on a basis of the degree of danger of the object that is calculated for each of the movement directions.

13. The information processing apparatus according to claim 8, wherein
the presentation control unit controls a shape of the danger prediction information on a basis of a range in which the object is predicted to move.

14. The information processing apparatus according to claim 8, wherein
the presentation control unit controls an angle formed by a side of the danger prediction information, on a basis of a predicted movement speed of the object.

15. The information processing apparatus according to claim 8, wherein
the presentation control unit controls a shape of the danger prediction information on a basis of the degree of danger of the object.

16. The information processing apparatus according to claim 1, wherein
the presentation control unit presents, to the user, dangerous environment information indicating a degree of danger of an environment around the moving body.

17. The information processing apparatus according to claim 1, wherein
the prediction unit predicts the movement information and the accident information on a basis of sensor data of a sensor which is provided to the moving body and which senses surroundings of the moving body.

18. The information processing apparatus according to claim 1, wherein
the prediction unit predicts the movement information and the accident information on a basis of information related to the object that is acquired from equipment other than the moving body.

19. An information processing method that is performed by an information processing apparatus, the information processing method comprising:
predicting movement information indicating a future movement of an object around a moving body and accident information indicating a movement of the object in a case where an accident occurs;
calculating a degree of danger of the object on a basis of the movement information and the accident information; and
presenting, to a user of the moving body, danger prediction information indicating the degree of danger of the object.

20. A program for causing a computer to execute processing comprising:
predicting movement information indicating a future movement of an object around a moving body and accident information indicating a movement of the object in a case where an accident occurs;
calculating a degree of danger of the object on a basis of the movement information and the accident information; and
presenting, to a user of the moving body, danger prediction information indicating the degree of danger of the object.
